(19) United States
(12) Patent Application Publication
(10) Pub. No.: US 2012/0154299 A1
(43) Pub. Date: Jun. 21, 2012

(54) TOUCH PANEL

(75) Inventors: Ching-Fu Hsu, Taichung County (TW); Ting-Yu Chang, Kaohsiung County (TW); Ying-Ching Tseng, Taichung City (TW); Chien-Min Tsai, New Taipei City (TW)

(73) Assignees: WINTEK CORPORATION, Taichung City (TW); DONGGUAN MASSTOP LIQUID CRYSTAL DISPLAY CO., LTD., Guangdong Province (CN)

(21) Appl. No.: 13/102,049

(22) Filed: May 5, 2011

(30) Foreign Application Priority Data
Dec. 16, 2010 (TW) 99144312

(51) Int. Cl. G06F 3/041

(52) U.S. Cl. 345/173

(57) ABSTRACT

A touch panel including a first substrate, a second substrate, a first electrode layer, a second electrode layer, a third electrode layer, and a transparent piezoelectric material layer is provided. The first substrate is opposite to the second substrate. The first electrode layer, the second electrode layer, and the third electrode layer are sequentially arranged and located between the first substrate and the second substrate. The first electrode layer, the second electrode layer, and the third electrode layer are separated from one another. The transparent piezoelectric material layer is disposed between the second electrode layer and the third electrode layer.

### CROSS-REFERENCE TO RELATED APPLICATION

This application claims the priority benefit of Taiwan application serial no. 99144312, filed Dec. 16, 2010. The entirety of the above-mentioned patent application is hereby incorporated by reference herein and made a part of this specification.

### BACKGROUND OF THE INVENTION

1. Field of the Invention

The invention relates to a touch panel, and more particularly, to a touch panel with sound functions.

2. Description of Related Art

Most portable electronic devices on the current market have sound functions such as an alarm clock or a music player. In addition, according to the user setting, the portable electronic device can play many different sound effects corresponding to, for example, an e-mail alert, text alert, or low battery alert. The above sound effects are played through speakers of the portable electronic device.

Generally, the speakers of the portable electronic device are disposed on the front face, and in the frame area of the device. However, new types of portable electronic devices are constantly replacing old ones, and the external designs trend towards a smaller and reduced volume. Speakers will limit the external design of portable electronic products. In order to reduce the limitation, the speakers can be designed on the back side of the portable electronic device. However, when the portable electronic device is placed on a table, since the back side faces down, the sound from the speakers will be blocked by the table. This causes a lower volume and may hinder the user from clearly hearing the sounds.

### SUMMARY OF THE INVENTION

The invention provides a touch panel that can produce sound and replace the configuration of speakers. Thus, the electronic device can omit the area required for a speaker configuration, allowing a larger display area. In addition, the touch panel provides a sound producing structure with a large area equipped with desirable sound volume, reducing the possibility of the user being unable to clearly hear the sound due to low volume.

The invention provides a touch panel including a first substrate, a second substrate, a first electrode layer, a second electrode layer, a third electrode layer, and a transparent piezoelectric material layer. The first substrate is opposite to the second substrate. The first electrode layer, the second electrode layer, and the third electrode layer are sequentially arranged and located between the first substrate and the second substrate, and the first electrode layer, the second electrode layer, and the third electrode layer are separated from one another. The transparent piezoelectric material layer is disposed between the second electrode layer and the third electrode layer.

Based on the above, the touch panel of the invention is disposed with a transparent piezoelectric material layer, and two electrode layers are disposed on the two sides of the transparent piezoelectric material layer. When the touch panel senses contact or when the user wants the electronic device with the touch panel to play a sound, the transparent piezoelectric material layer will vibrate and produce sound because of the change in voltage between the two electrode layers. Since the transparent piezoelectric material layer is disposed on the overall operating area of the touch panel, the touch panel has a large area to produce sound which helps in raising the volume of the sound.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 shows a touch panel according to the first embodiment of the invention.

FIG. 2 shows a touch panel according to the second embodiment of the invention.

FIG. 3 is a partial schematic top view of touch panel shown in FIG. 2.

FIG. 4 shows a touch panel according to the third embodiment of the invention.

FIG. 5 is a top schematic view of an electrode layer in the sound producing structure.

FIG. 6 shows a touch panel according to the fourth embodiment of the invention.

FIG. 7 shows a touch panel according to the fifth embodiment of the invention.

FIG. 8 shows a touch panel according to the sixth embodiment of the invention.

### DESCRIPTION OF EMBODIMENTS

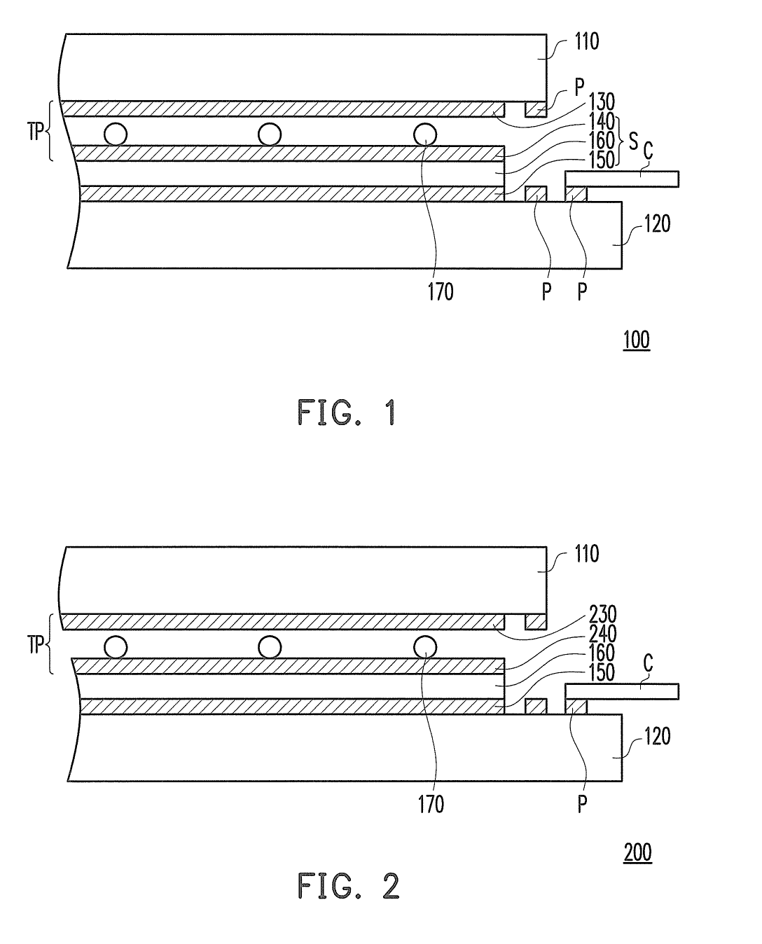

FIG. 1 shows a touch panel according to the first embodiment of the invention. Referring to FIG. 1, a touch panel 100 includes a first substrate 110, a second substrate 120, a first electrode layer 130, a second electrode layer 140, a third electrode layer 150, a transparent piezoelectric material layer 160, and a plurality of spacers 170. The first substrate 110 is configured opposite to the second substrate 120. The first electrode layer 130, the second electrode layer 140, and the third electrode layer 150 are sequentially arranged and located between the first substrate 110 and the second substrate 120, and the first electrode layer 130, the second electrode layer 140, and the third electrode layer 150 are separated from one another. The transparent piezoelectric material layer 160 is disposed between the second electrode layer 140 and the third electrode layer 150. In addition, the spacers 170 are disposed between the first electrode layer 130 and the second electrode layer 140.

In the embodiment, the first electrode layer 130, the spacers 170, and the second electrode layer 140, for example, form a touch sensing structure TP with a resistive type touch sensing function. In addition, the first electrode layer 130, the second electrode layer 140, and the third electrode layer 150 can be electrically connected to a control circuit C through a plurality of bonding pads P. When the user presses the touch panel 100 through the first substrate 110 or the second substrate 120, the first electrode layer 130 and the second electrode layer 140 can be conducted, which creates a corresponding contact signal at the pressed area. The control circuit C can calculate the position the user pressed according to the aforementioned touch control signal. In the embodiment, the control circuit C is connected to the second substrate 120, but the invention is not limited thereto. In other embodiments, the control circuit C may be connected to the first substrate 110, or directly fabricated on one of the first substrate 110 or the second substrate 120 to make up a chip on glass (COG) design.

In addition, the transparent piezoelectric material layer 160 is disposed between the second electrode layer 140 and the third electrode layer 150, and the material thereof is, for example, polyvinylidene fluoride (PVDF). Because of the PVDF characteristics, if there is a change in voltage between the second electrode 140 and the third electrode 150, the transparent piezoelectric material layer 160 will vibrate, which produces sound. Thus, the transparent piezoelectric material layer 160 disposed between the second electrode layer 140 and the third electrode layer 150 can form a sound producing structure S of the touch panel 100. Therefore, an electronic device using the touch panel 100 can produce sound without an additional speaker configuration, so that the electronic device has a reduced volume.

Specifically, the first electrode layer 130, the second electrode layer 140, and the third electrode layer 150 are all electrically connected to the control circuit C. Thus, when the user needs the electronic device to produce a sound, the control circuit C of the touch panel 100 can transmit the corresponding signal to the second electrode layer 140 and the third electrode layer 150, so that the transparent piezoelectric material layer 160 vibrates and produces the required sound. In addition, when the user presses the second electrode layer 140 of the touch panel 100, it will also cause a change in voltage of the second electrode layer 140. Thus, when the user presses the touch panel 100, the transparent piezoelectric material layer 160 can also produce a sound according to the aforementioned change in voltage.

In general, the transparent piezoelectric material layer 160 can produce sound according to the touch operation of the user, and can also produce sound according to the signal of the control circuit C. Thus, besides providing a touch sensing function, the touch panel 100 further provides a sound function. The electronic device with the aforementioned touch panel 100 of the invention can directly perform functions such as playing music or sounding alerts. In addition, when the user touches the touch panel 100, the vibration of the transparent piezoelectric material layer 160 can be sensed by the user, and provide the user with a different tactile sensation.

In the embodiment, the touch panel 100 can substantially be integrated with a display panel, wherein either the first substrate 110 or the second substrate 120 can be the substrate for the display panel. In addition, the other first substrate 110 or second substrate 120 may be a decorative cover plate. Of course, the first substrate 110 and the second substrate 120 can respectively be a glass substrate, a plastic substrate, or any other load bearing substrate.

In the embodiment, the transparent piezoelectric material layer 160 has a transparent property, so the transparent piezoelectric material layer 160 can be disposed on the overall touch area of the touch panel 100. In other words, the transparent piezoelectric material layer 160 will not block the displayed light and will not limit the external design of the electronic device. In a conventional electronic device that can only be designed with speakers on the frame, the frame requires a certain width. When applying the touch panel 100 of the embodiment on an electronic device, it will not require a frame with a large width, aiding in reducing the volume of the electronic device. In addition, the transparent piezoelectric material layer 160 that is disposed on the overall touch operating area of the touch panel 100, i.e. the overall area the first electrode layer 130 is covered, has a large area to effectively produce sound and increase sound volume. Furthermore, the area of the touch panel 100 that can produce sound is not limited to a specified partial area, which helps improve the uniformity of the sound producing area. Of course, in different design requirements, the transparent piezoelectric material layer 160 can be partially disposed around the edge of the touch panel 100, and not disposed on the overall touch operating area of the touch panel 100.

In addition, the first electrode layer 130 and the second electrode layer 140 of the touch panel 100 are described as a conductive layer disposed on the overall touch operating area of the touch panel 100, but the invention is not limited thereto. Specifically, the invention can further adopt multiple methods to achieve the touch sensing function of the touch panel 100. Thus, multiple embodiments are provided below, and the scope of the invention is described without limiting the premise of the invention. It should be noted that the touch sensing structures and sound producing structures of the embodiments below both can be connected to a control circuit. The structures undergo touch sensing calculations through the control circuit, and the control circuit controls the vibration and sound produced by the transparent piezoelectric material layer.

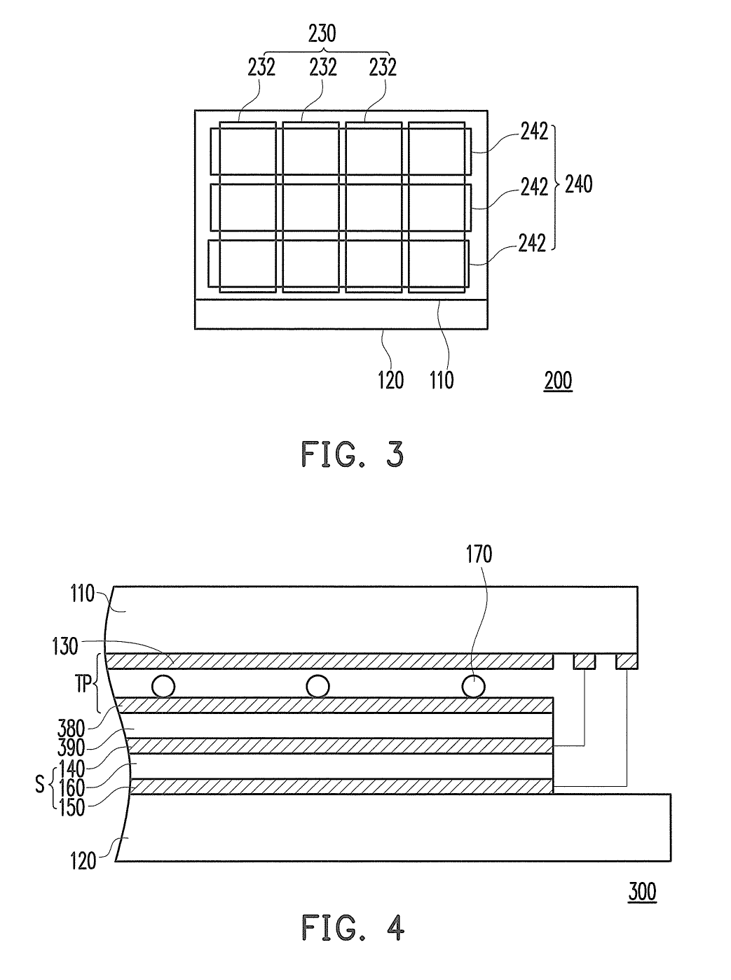

FIG. 2 shows a touch panel according to the second embodiment of the invention. FIG. 3 is a partial schematic top view of touch panel shown in FIG. 2. Referring to FIG. 2 and FIG. 3, a touch panel 200 is similar to the touch panel 100, while the difference therebetween lies in that a first electrode layer 230 and a second electrode layer 240 of the touch panel 200 are not completely disposed on the overall touch operating area of the touch panel 200. In detail, the first electrode layer 230 comprises a plurality of first stripe electrodes 232, and the second electrode layer 240 comprises a plurality of second stripe electrodes 242, and a direction the first stripe electrodes 232 extend intersects with a direction the second stripe electrodes 242 extend. Therefore, the first electrode layer 230, the second electrode layer 240, and the spacers 170 between the two electrode layers form a touch sensing structure TP with a resistance type multi-points touch sensing function.

FIG. 4 shows a touch panel according to the third embodiment of the invention. Referring to FIG. 4, a touch panel 300 besides including the first substrate 110, the second substrate 120, the first electrode layer 130, the second electrode layer 140, the third electrode layer 150, the transparent piezoelectric material layer 160, and the plurality of spacers 170 of the touch panel 100, further includes a fourth electrode layer 380 and an insulating layer 390. The insulating layer 390 is disposed between the fourth electrode layer 380 and the second electrode layer 140, and the fourth electrode layer 380 is disposed between the insulating layer 390 and the spacers 170. The first electrode layer 130, the spacers 170, and the fourth electrode layer 380 together construct the touch sensing structure TP, and the second electrode layer 140, the transparent piezoelectric material layer 160, and the third electrode layer 150 together construct the sound producing structure S. In the embodiment, the touch sensing structure TP and the sound producing structure S are separated by the insulating layer 390, and are operated independently.

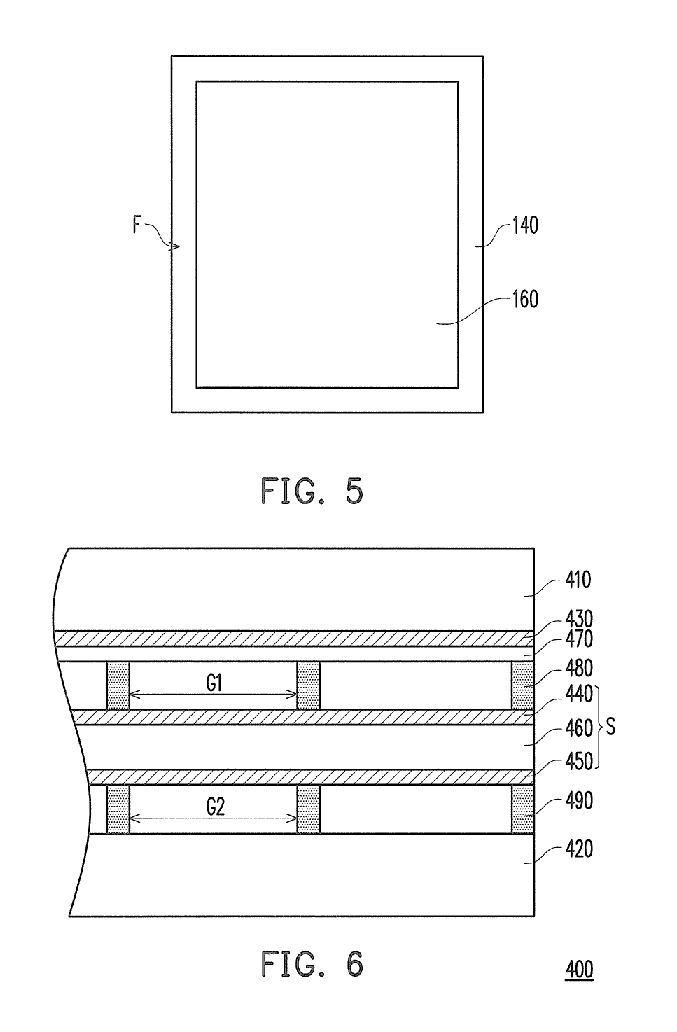

In addition, FIG. 5 is a top schematic view of an electrode layer in the sound producing structure. Referring to FIG. 4 and FIG. 5, in an embodiment, the second electrode layer 140 or the third electrode layer 150 can be formed in the shape of a ring pattern F (the second electrode layer 140 of FIG. 5 is described as being formed in the shape of a ring pattern F, for example), disposed around the transparent piezoelectric material layer 160. Therefore, the design of the second electrode layer 140 or the third electrode layer 150 can allow a distance (the thickness of the second electrode 140 or the third electrode 150) between the transparent piezoelectric material layer 160 and its adjacent components, to define a resonance box structure and help the transparent piezoelectric material layer 160 produce sound. In other words, the invention does not limit the second electrode layer 140 or the third electrode layer 150 to be disposed on the overall touch operating area of the touch panel 300.

FIG. 6 shows a touch panel according to the fourth embodiment of the invention. Referring to FIG. 6, a touch panel 400 includes a first substrate 410, a second substrate 420, a first electrode layer 430, a second electrode layer 440, a third electrode layer 450, a transparent piezoelectric material layer 460, an insulating layer 470, a plurality of first padding elements 480, and a plurality of second padding elements 490. The first substrate 410 is configured opposite to the second substrate 420. The first electrode layer 430, the second electrode layer 440, and the third electrode layer 450 are sequentially arranged and located between the first substrate 410 and the second substrate 420. The transparent piezoelectric material layer 460 is disposed between the second electrode layer 440 and the third electrode layer 450, and the material thereof is PVDF. The insulating layer 470 is disposed between the first electrode layer 430 and the second electrode layer 440. In the embodiment, the second electrode layer 440, the transparent piezoelectric layer 460, and the third electrode layer 450 are stacked into a sound producing structure S. The first padding elements 480 and the second padding elements 490 are respectively located on the two opposite sides of the sound producing structure S.

The first padding elements 480 and the second padding elements 490 can respectively surround the transparent piezoelectric material layer 460 to form a resonance box structure, so the transparent piezoelectric material layer 460 vibrates when there is a change in voltage between the second electrode layer 440 and the third electrode layer 450. In addition, the first padding elements 480 are separated by a gap G1, and the second padding elements are separated by a gap G2. When the transparent piezoelectric material layer 460 vibrates and produces sound, the sound can be transmitted through the gap G1 and the gap G2 to the outside and reach the user. That is to say, the gap G1 and the gap G2 provide a sound transmission channel so the sound produced by the transparent piezoelectric material layer 460 can reach the external world.

In the embodiment, the first electrode layer 430, for example, can be a surface capacitive type touch sensing structure through a single layer of transparent conductive material, or be a projection capacitor type touch sensing structure through a plurality of first sensing series and a plurality of second sensing series. When the first electrode layer 430 uses an assembly of a plurality of first sensing series and a plurality of second sensing series, the direction each first sensing series extends intersects can be perpendicular with the direction each second sensing series extends. When undergoing touch sensing, the first electrode layer 430 produces a change in capacitance due to a touch operation of the user. At that moment, a driving chip or a driving circuit (not shown) used for touch controlling will obtain a touch coordinate according to the change in capacitance. After transmitting a signal to the control circuit (not shown) of the touch panel 400, the control circuit further transmits the control signal to the second electrode layer 440 and the third electrode layer 450, so the transparent piezoelectric material layer 460 vibrates and produces sound corresponding to the touch of the user. That is to say, when the user touches the touch panel 400, the transparent piezoelectric material layer 460 can produce sound through the control of the control circuit, so that the user will hear the corresponding sound when touching, enjoying the experience of multi-function variation.

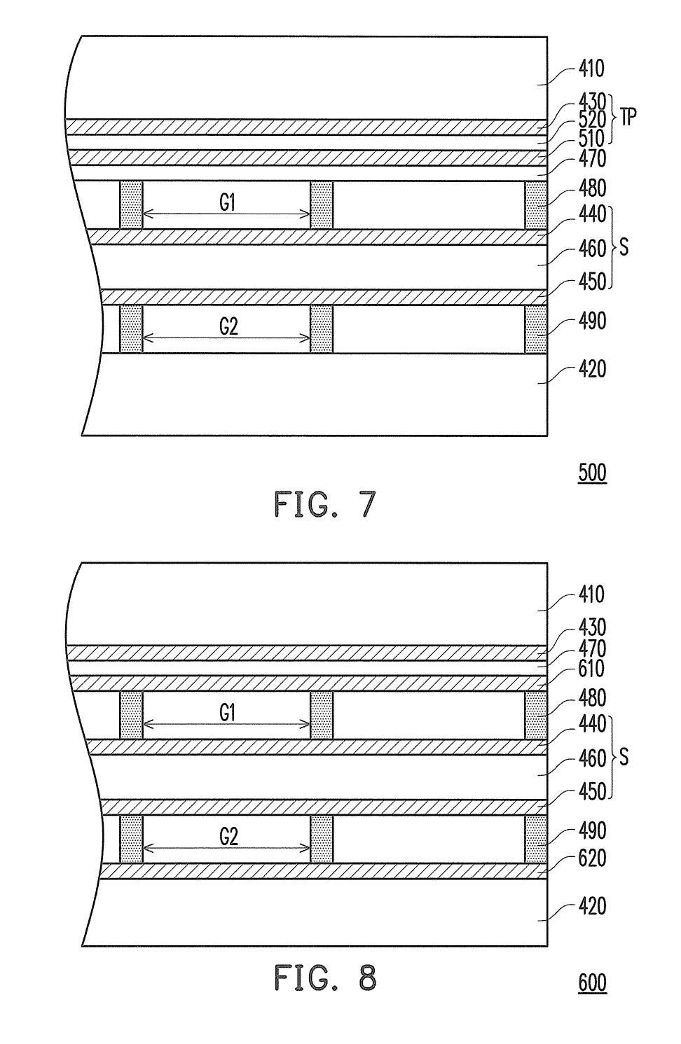

FIG. 7 shows a touch panel according to the fifth embodiment of the invention. Referring to FIG. 7, a touch panel 500 is similar to the touch panel 400, while the difference therebetween lies in that the touch panel 500 further comprises a fourth electrode layer 510 and an insulating layer 520. In the embodiment, the fourth electrode layer 510 is disposed between the first electrode layer 430 and the insulating layer 470, and the insulating layer 520 is disposed between the fourth electrode layer 510 and the first electrode layer 430. The first electrode layer 430, the insulating layer 520, and the fourth electrode layer 510 together construct a touch sensing structure TP, and the touch sensing structure TP of the embodiment has a capacitive type touch sensing function. Of course, in other embodiments, the insulating layer 520 can be replaced by the plurality of spacers 170 shown in FIG. 1, causing the touch panel 500 to have a resistive type touch sensing function.

The design of the touch sensing structure TP is not limited thereto. In other embodiments, the fourth electrode layer 510 can be selectively disposed on a side of the first substrate 410 away from the first electrode layer 430. As such, the touch panel 500 can omit the configuration of the insulating layer 520. In addition, the first electrode layer 430 and the fourth electrode layer 510 can each be formed by a plurality of stripe electrodes or a plurality of sensing series.

Furthermore, in order to avoid mutual interference in the signal between each component, FIG. 8 further shows another embodiment. FIG. 8 shows a touch panel according to the sixth embodiment of the invention. Referring to FIG. 8, a touch panel 600 is similar to the touch panel 400, while the difference therebetween lies in that the touch panel 600 further includes shielding electrode layers 610 and 620. The first padding elements 480 are disposed between the shielding electrode layer 610 and the second electrode layer 440, and the shielding electrode layer 620 is disposed between the second padding elements 490 and the second substrate 420.

The shielding electrode layer 610 can prevent signal interference between the first electrode layer 430 and the sound producing structure S, and the shielding electrode layer 620 can prevent signal interference between the sound producing structure S and the components outside the second substrate 420. For example, when the second substrate 420 is the substrate for a display panel, the configuration of the shielding electrode layer 620 can effectively prevent signal interference between the display panel and the sound producing structure S. As such, the touch panel 600 can have a good touch sensing function and a good sound producing effect. The touch sensing display panel configured with the touch panel 600 can also have a good display effect. Furthermore, the electronic device using the touch panel 600 can have narrow edges, satisfying the design for a small overall volume.

Generally, the invention disposes two electrode layers in the touch panel and a transparent piezoelectric material layer between the two electrode layers to form a sound producing structure. Thus, besides providing a touch sensing function, the touch panel further provides a sound function to replace the conventional use of speakers. When applying the touch panel in electronic devices, speakers can be omitted, allowing the overall volume to the electronic device to be reduced. In addition, the sound producing structure can be transparent, and so the display area of the electronic device will not be limited by the sound producing structure. Since the transparent piezoelectric material layer is disposed on the overall touch operating area of the touch panel, the touch panel has a large area to produce sound which helps in raising the volume of the sound.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch panel, comprising:
a first substrate;
a second substrate opposite to the first substrate;
a first electrode layer;
a second electrode layer;
a third electrode layer, the first electrode layer, the second electrode layer, and the third electrode layer being sequentially arranged and located between the first substrate and the second substrate, and the first electrode layer, the second electrode layer, and the third electrode layer being separated from one another; and
an transparent piezoelectric material layer, disposed between the second electrode layer and the third electrode layer.

2. The touch panel as claimed in claim 1, further comprising a plurality of spacers, disposed between the first electrode layer and the second electrode layer.

3. The touch panel as claimed in claim 2, wherein the first electrode layer comprises a plurality of first stripe electrodes, and the second electrode layer comprises a plurality of second stripe electrodes, and a direction each of the first stripe electrodes extends intersects with a direction each of the second stripe electrodes extends.

4. The touch panel as claimed in claim 1, further comprising a first insulating layer, disposed between the first electrode layer and the second electrode layer.

5. The touch panel as claimed in claim 4, further comprising a fourth electrode layer and a plurality of spacers, wherein the fourth electrode layer is disposed between the first electrode layer and the first insulating layer, and the spacers are disposed between the fourth electrode layer and the first electrode layer.

6. The touch panel as claimed in claim 4, further comprising a plurality of first padding elements and a plurality of second padding elements, the first padding elements are disposed between the first insulating layer and the second electrode layer, the second padding elements are disposed between the third electrode layer and the second substrate, and adjacent first padding elements are separated by a first gap and adjacent second padding elements are separated by a second gap.

7. The touch panel as claimed in claim 6, further comprising a first shielding electrode layer and a second shielding electrode layer, wherein the first padding elements are disposed between the first shielding electrode layer and the second electrode layer, and the second shielding electrode layer is disposed between the second padding elements and the second substrate.

8. The touch panel as claimed in claim 4, wherein the first electrode layer comprises a plurality of first sensing series and a plurality of second sensing series, a direction each of the first sensing series extends intersects with a direction each of the second sensing series extends.

9. The touch panel as claimed in claim 4, further comprising a fourth electrode layer and a second insulating layer, the fourth electrode layer is disposed between the first electrode layer and the first insulating layer, and the second insulating layer is disposed between the fourth electrode layer and the first electrode layer.

10. The touch panel as claimed in claim 1, wherein the transparent piezoelectric material layer is substantially disposed on the overall area covered by the first electrode.
